(19) United States
(12) Patent Application Publication
(10) Pub. No.: US 2026/0290920 A1
(43) Pub. Date: Sep. 24, 2026

(54) SECONDARY ENERGY STORAGE DEVICE AND SYSTEM AND METHOD OF FORMING THE DEVICE

(71) Applicant: GM GLOBAL TECHNOLOGY OPERATIONS LLC, Detroit, MI (US)

(72) Inventors: Ian Yu, Ypsilanti, MI (US); Jihyun Kim, Rochester Hills, MI (US)

(73) Assignee: GM GLOBAL TECHNOLOGY OPERATIONS LLC, Detroit, MI (US)

(21) Appl. No.: 19/086,282

(22) Filed: Mar. 21, 2025

(51) Int. Cl. H01M 10/48; H01M 10/42; H01M 50/103; H01M 50/15; H01M 50/55

(52) U.S. Cl. CPC H01M 10/486; H01M 10/4257; H01M 50/103; H01M 50/15; H01M 50/55; H01M 2010/4271; H01M 2220/20

(57) ABSTRACT

A secondary energy storage device includes a rigid enclosure defining a cavity therein. The rigid enclosure includes a front face extending along a central longitudinal axis and a cap plate that contacts and is disposed perpendicular to the front face and extends along an axis that is parallel to the central longitudinal axis. The device includes a negative electrode terminal electrically isolated from the cap plate and having an external portion disposed on the cap plate outside of the cavity and an internal portion extending into the cavity. The device also includes a thermistor disposed within the cavity and electrically connected to the internal portion and cap plate, a first sensing conduit electrically connected to the external portion, and a second sensing conduit electrically connected to the cap plate. A secondary energy storage system and a method of forming the secondary energy storage device are also described.

### INTRODUCTION

The disclosure relates to a secondary energy storage device, a secondary energy storage system, and a method of forming the secondary energy storage device.

Energy storage devices, such as batteries, are useful for converting chemical energy into electrical energy, and may be described as primary or secondary. Primary energy storage devices are generally non-rechargeable, whereas secondary energy storage devices are readily rechargeable and may be restored to a full charge after use. As such, secondary energy storage devices may be useful for applications such as powering electronic devices, tools, machinery, and vehicles. For example, secondary energy storage devices for vehicle applications may be recharged external to the vehicle via a plug-in electrical outlet, or onboard the vehicle via a regenerative event.

One type of secondary energy storage device, a lithium ion secondary battery, may include a negative electrode or anode, a positive electrode or cathode, and an electrolyte disposed between the positive and negative electrodes. The negative electrode may be formed from a material that is capable of incorporating and releasing lithium ions during charging and discharging of the lithium ion secondary battery. More specifically, during charging of the lithium ion secondary battery, lithium ions may move from the positive electrode to the negative electrode and embed in the material. Conversely, during battery discharge, lithium ions may be released from the material and move from the negative electrode to the positive electrode. Under certain operating conditions, such secondary energy storage devices may experience changes in temperature and electrical properties.

### SUMMARY

A secondary energy storage device includes a rigid enclosure having a rectangular prism shape and defining a cavity therein. The rigid enclosure has a front face extending along a central longitudinal axis, and a cap plate that contacts and is disposed perpendicular to the front face and extends along an axis that is parallel to the central longitudinal axis. The secondary energy storage device also includes a negative electrode terminal electrically isolated from the cap plate and having an external portion disposed on the cap plate outside of the cavity and an internal portion extending into the cavity. Further, the secondary energy storage device has a thermistor disposed within the cavity and electrically connected to the internal portion and the cap plate, a first sensing conduit electrically connected to the external portion, and a second sensing conduit electrically connected to the cap plate.

In one aspect, the secondary energy storage device may further include an insulation cover disposed between and in contact with the cap plate and the internal portion and defining a void therethrough.

In an additional aspect, the secondary energy storage device may further include a third conduit electrically connecting the internal portion and the thermistor and a fourth conduit extending through the void and electrically connecting the thermistor and the cap plate.

In another aspect, the third conduit and the fourth conduit may not extend through the cap plate.

In a further aspect, the secondary energy storage device may further include a first weld joint electrically connecting the third conduit and the internal portion, a second weld joint electrically connecting the fourth conduit and the cap plate, a third weld joint electrically connecting the first sensing conduit and the external portion, and a fourth weld joint electrically connecting the second sensing conduit and the cap plate.

In one aspect, the secondary energy storage device may further include an insulator gasket disposed between and in contact with the external portion and the cap plate.

In another aspect, the thermistor may have an electrical resistance of from 1 kiloohm (kΩ) to 150 kΩ at 25 degrees Celsius (°C).

In an additional aspect, the secondary energy storage device may further include a positive electrode terminal and the secondary energy storage device may be a can-positive secondary energy storage device in which the cap plate is electrically connected to the positive electrode terminal and electrically isolated from the negative electrode terminal.

In another aspect, the secondary energy device may further include a positive electrode terminal and the secondary energy storage device may be a can-neutral secondary energy storage device in which the cap plate is electrically isolated from the positive electrode terminal and the negative electrode terminal.

In a further aspect, a vehicle may include the secondary energy storage device.

A secondary energy storage system includes a secondary energy storage device including a rigid enclosure having a rectangular prism shape and defining a cavity therein. The rigid enclosure has a front face extending along a central longitudinal axis and a cap plate that contacts and is disposed perpendicular to the front face and extends along an axis that is parallel to the central longitudinal axis. The secondary energy storage device has a negative electrode terminal electrically isolated from the cap plate and having an external portion disposed on the cap plate outside of the cavity and an internal portion extending into the cavity. The secondary energy storage device also has a thermistor disposed within the cavity and electrically connected to the internal portion and the cap plate, a first sensing conduit electrically connected to the external portion, and a second sensing conduit electrically connected to the cap plate. In addition, the secondary energy storage system includes a battery management system electrically connected to the first sensing conduit and the second sensing conduit and configured for monitoring and measuring at least one of a voltage, temperature, and current flow of the secondary energy storage device.

In one aspect, the battery management system includes a voltage divider circuit including a pull-up resistor.

In another aspect, the secondary energy storage system may further include an insulation cover disposed between and in contact with the cap plate and the internal portion and defining a void therethrough, a third conduit electrically connecting the internal portion and the thermistor, and a fourth conduit extending through the void and electrically connecting the thermistor and the cap plate. The third conduit and the fourth conduit may not extend through the cap plate.

In an additional aspect, the secondary energy storage system may further include a plurality of secondary energy storage devices each electrically connected to one another and to the battery management system.

A method of forming a secondary energy storage device includes inserting a thermistor into a cavity defined by a rigid enclosure of the secondary energy storage device. The rigid enclosure has a prism shape, a front face extending along a central longitudinal axis, and a cap plate that contacts and is disposed perpendicular to the front face and extends along an axis that is parallel to the central longitudinal axis. The secondary energy storage device includes a negative electrode terminal electrically isolated from the cap plate and having an external portion disposed on the cap plate outside of the cavity and an internal portion extending into the cavity. After inserting, the method includes electrically connecting the thermistor to the internal portion and the cap plate to thereby form a workpiece. After electrically connecting the thermistor, the method includes welding a first sensing conduit to the external portion and a second sensing conduit to the cap plate.

In one aspect, the secondary energy storage device may further include an insulation cover disposed between and in contact with the cap plate and the internal portion and defining a void therethrough; a third conduit electrically connecting the internal portion and the thermistor; and a fourth conduit extending through the void and electrically connecting the thermistor and the cap plate. Electrically connecting the thermistor may include forming a first weld joint to electrically connect the third conduit and the internal portion and forming a second weld joint to electrically connect the fourth conduit and the cap plate.

In an additional aspect, the method may further include, after electrically connecting the thermistor and prior to welding the first sensing conduit and the second sensing conduit, electrically connecting together a plurality of the workpieces.

In another aspect, welding may include, for each of the plurality of workpieces, forming a third weld joint to electrically connect the first sensing conduit and the external portion and forming a fourth weld joint to electrically connect the second sensing conduit and the cap plate.

In a further aspect, the method may further include, after welding the first sensing conduit and the second sensing conduit, disposing the first sensing conduit and the second sensing conduit in electrical communication with a battery management system configured for monitoring and measuring at least one of a voltage, temperature, and current flow of the secondary energy storage device.

In one aspect, the secondary energy storage device may further include an insulation cover disposed between and in contact with the cap plate and the internal portion and defining a void therethrough, a third conduit electrically connecting the internal portion and the thermistor, and a fourth conduit extending through the void and electrically connecting the thermistor and the cap plate. The method may further include, concurrent to electrically connecting, preserving an integrity of the cap plate such that the third conduit and the fourth conduit do not extend through the cap plate.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is a schematic illustration of a side view of a secondary energy storage device.

FIG. 2 is a schematic illustration of an exploded, perspective view of a vehicle including a plurality of the secondary energy storage devices of FIG. 1 that are arranged into a plurality of secondary energy storage packs arranged into a secondary energy storage module.

FIG. 3 is a schematic illustration of a perspective view of a cap plate, a negative electrode, and a thermistor of the secondary energy storage device of FIG. 1.

FIG. 4 is a schematic illustration of a bottom view of an insulator cover disposed in contact with the cap plate and negative electrode of FIG. 3.

FIG. 5 is a schematic flow diagram of a method of forming the secondary energy storage device of FIG. 1.

### DETAILED DESCRIPTION

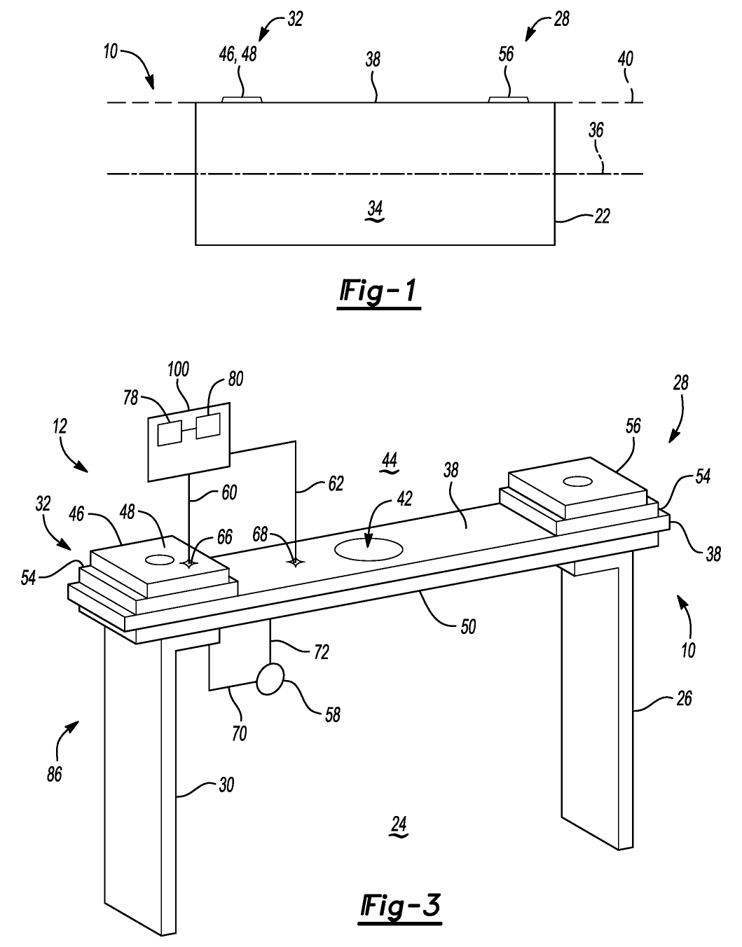

Referring to the Figures, wherein like reference numerals refer to like elements, a secondary energy storage device 10 (FIGS. 1 and 3), a secondary energy storage system 12 (FIG. 3), and a method 14 (FIG. 5) of forming the secondary energy storage device 10 are shown generally. The secondary energy storage device 10, system 12, and method 14 may be useful for applications requiring field monitoring of an internal temperature of the secondary energy storage device 10 and applications requiring secondary energy storage devices 10 having robust mechanical integrity during operation under various conditions.

In particular, the secondary energy storage device 10, system 12, and method 14 may be useful for applications requiring long-term testing and/or operation of secondary energy storage devices 10 under harsh or abusive conditions while measuring the internal temperature of the secondary energy storage device 10 and without compromising a structural integrity of the secondary energy storage device 10, even under conditions in which the secondary energy storage device 10 generates significant internal pressure. As such, the secondary energy storage device 10 may be suitable for applications requiring long-term cycling or operation of the secondary energy storage device 10 and system 12 in harsh or unexpected conditions, and the method 14 may be suitable for high-volume manufacturing requiring handling and multiple welding processes.

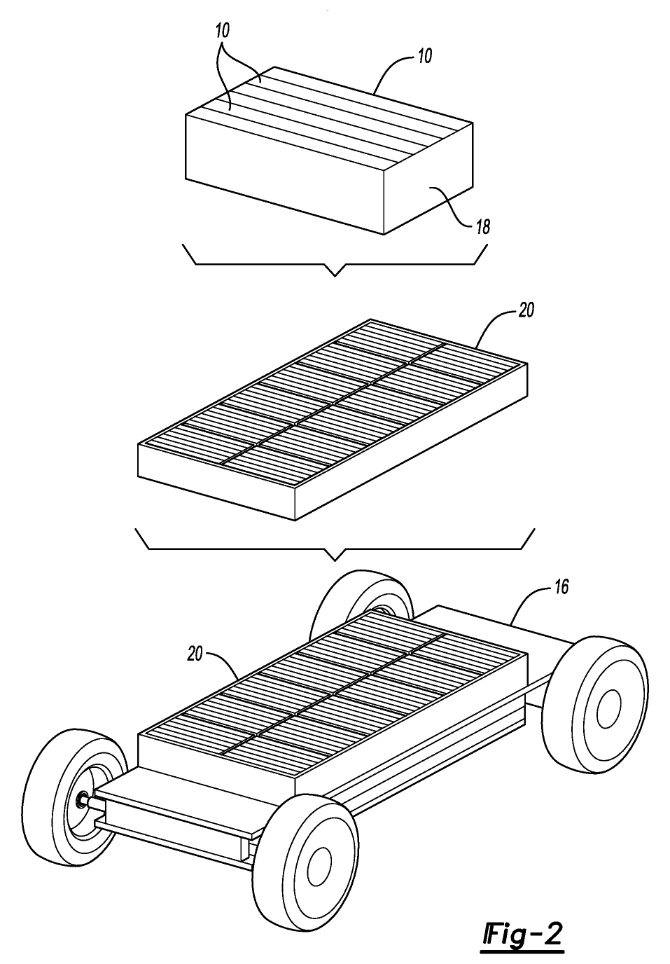

In one non-limiting example, the secondary energy storage device 10 may be a lithium ion secondary battery as shown in FIG. 1. That is, the secondary energy storage device 10 may be useful for applications requiring lithium ion secondary batteries having excellent electrical conductivity, mechanical integrity, specific energy capacity, performance, manufacturing cost, and operating life. Therefore, the secondary energy storage device 10 may be useful for a variety of applications, such as, but not limited to, electronic devices, tools, machinery, and vehicles 16 (FIG. 2). For example, the secondary energy storage device 10 may be useful for lithium ion secondary batteries for electric and hybrid electric vehicles. However, it is to be appreciated that the secondary energy storage device 10 may also be useful for non-automotive applications, such as, but not limited to, household and industrial power tools and electronic devices.

Referring now to FIG. 2 and for purposes of general explanation pertaining to automotive applications, a plurality of secondary energy storage devices 10 may be combined to form a secondary energy storage module 18, e.g., a lithium ion secondary battery module. The secondary energy storage module 18 may be useful for automotive applications such as a hybrid electric vehicle (HEV), an electric vehicle (EV), a plug-in hybrid electric vehicle (PHEV), and the like. Further, a plurality of secondary energy storage modules 18 may be combined to form a secondary energy storage pack 20, e.g., a lithium ion secondary battery pack, as also shown in FIG. 2. By way of example, the secondary energy storage pack 20 may be sufficiently sized to provide a voltage for powering an HEV, an EV, a PHEV, and the like, e.g., approximately 300 to 400 volts or more, depending on the required application.

Referring again to FIG. 2, the secondary energy storage module 18 may include a plurality of secondary energy storage devices 10 positioned adjacent to and spaced from one another. As such, the secondary energy storage device 10 may be suitable for stacking. More specifically and as best shown in FIG. 1, the secondary energy storage device 10 includes a rigid enclosure 22 having a rectangular prism shape or cuboid shape and may be characterized as a prismatic secondary energy storage device 10. The rigid enclosure 22 may be formed from a metal, such as aluminum or steel, and defines a cavity 24 (FIG. 3) therein that may be sealed to enclose an interior portion 26 of a cathode or positive electrode 28, an internal portion 30 of an anode or negative electrode 32, a separator (not shown), and an electrolyte (not shown).

Therefore, the plurality of secondary energy storage devices 10 may be stacked or otherwise placed adjacent to each other to form a cell stack, i.e., the secondary energy storage module 18. Further, although not shown, additional layers, such as, but not limited to, frames and/or cooling layers may also be positioned in a space between individual secondary energy storage devices 10. The actual number of secondary energy storage devices 10 may be expected to vary with the desired voltage output of each secondary energy storage module 18. Likewise, the number of interconnected secondary energy storage modules 18 may vary to produce the total output voltage for a specific application.

In general, during operation of the secondary energy storage device 10, a chemical redox reaction may transfer electrons between a region of relatively negative potential to a region of relatively positive potential to thereby cycle, i.e., charge and discharge, the secondary energy storage device 10 and the secondary energy storage pack 20 to provide voltage to power applications. In particular, a plurality of lithium ions (not shown) may transfer between the positive electrode 28 (FIG. 3) and the negative electrode 32 (FIG. 3) during charging and discharging of the secondary energy storage device 10.

Therefore, the secondary energy storage device 10, system 12, and method 14 may be useful for automotive applications such as, but not limited to, vehicles 16 (FIG. 2) including internal combustion engine vehicles, electric vehicles, hybrid vehicles, and the like. For example, the vehicle 16 may be a motor vehicle powered by a motive power source including at least one of an internal combustion engine, an electric motor, and an energy storage device, and the vehicle 16 may include the secondary energy storage device 10.

Further, the vehicle 16 may be configured for autonomous or automated driving in which the vehicle 16 may be controlled or driven by technology including hardware and software, whether remote to the vehicle 16 or onboard the vehicle 16, that is capable of driving the vehicle 16 without active physical control by a human operator. For example, autonomous or automated driving tasks may include, but are not limited to, object and event detection, recognition, and classification; object and event response; maneuver planning; steering, turning, lane-keeping, signaling, and lane changing; and acceleration and deceleration.

Alternatively, the secondary energy storage device 10, system 12, and method 14 may be useful for non-automotive applications such as, but not limited to, aerospace, aviation, marine, mass transportation, agricultural, industrial, and rail applications. For example, the vehicle 16 may be, but is not limited to, a commercial vehicle, industrial vehicle, passenger vehicle, automated guided vehicle (AGV), aircraft, watercraft, train, trolley, bus, or the like. It is also contemplated that the vehicle 16 may be a mobile platform, such as an airplane, all-terrain vehicle (ATV), boat, personal movement apparatus, robot, and the like to accomplish the purposes of this disclosure.

### Secondary Energy Storage Device

Referring now to FIG. 1, the rigid enclosure 22 of the secondary energy storage device 10 includes a front face 34 extending along a central longitudinal axis 36. That is, the front face 34 may have a generally rectangular shape, may be formed from metal, and may have a longest dimension extending along the central longitudinal axis 36. The rigid enclosure 22 also includes a cap plate 38 that contacts and is disposed perpendicular to the front face 34 and extends along an axis 40 that is parallel to the central longitudinal axis 36. As best shown in FIG. 3, the cap plate 38 may also define a vent 42 configured for alternatingly fluidly communicating with and sealing off the cavity 24 from an environment 44 ambient to the cap plate 38.

As described with continued reference to FIG. 3, the secondary energy storage device 10 also includes a negative electrode terminal 46 electrically isolated from the cap plate 38 and having an external portion 48 disposed on the cap plate 38 outside of the cavity 24 and the internal portion 30 extending into the cavity 24. That is, the external portion 48 may be visible from an exterior of the secondary energy storage device 10 as shown in FIG. 1, and the internal portion 30 may be disposed within the cavity 24 and may not be visible from the exterior of the secondary energy storage device 10.

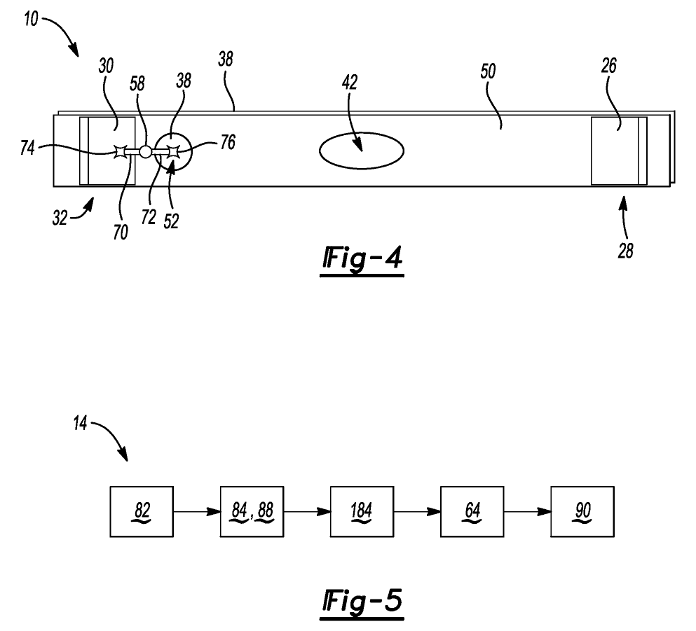

Referring again to FIG. 3, the secondary energy storage device 10 may also include an insulation cover 50 disposed between and in contact with the cap plate 38 and the internal portion 30 to electrically isolate the negative electrode terminal 46 from the cap plate 38. As set forth in more detail below and best shown in FIG. 4, the insulation cover 50 may define a void 52 therethrough. Further, as shown in FIG. 3, the secondary energy storage device 10 may include an insulator gasket 54 disposed between and in contact with the external portion 48 and the cap plate 38 to likewise electrically isolate the negative electrode terminal 46 from the cap plate 38.

Referring again to FIG. 1, the secondary energy storage device 10 may also include a positive electrode terminal 56. In one example, the secondary energy storage device 10 may be a can-positive secondary energy storage device 10 in which the cap plate is electrically connected to the positive electrode terminal 56 and electrically isolated from the negative electrode terminal 46. That is, the rigid enclosure 22 may serve as the positive electrode 28 of the secondary energy storage device 10. In another example, the secondary energy storage device 10 may be a can-neutral secondary energy storage device 10 in which the cap plate 38 is electrically isolated from the positive electrode terminal 56 and the negative electrode terminal 46.

As described with reference to FIG. 3, the secondary energy storage device 10 also includes a thermistor 58 disposed within the cavity 24 and electrically connected to the internal portion 30 and the cap plate 38. That is, the thermistor 58 may be disposed internally within the cavity 24 of the rigid enclosure 22. As set forth in more detail below, although the thermistor 58 is disposed within the cavity 24, the cap plate 38 may not be cut or structurally compromised or require resealing, for example with a room temperature vulcanizing sealant, to insert the thermistor 58 within the cavity 24. As such, the cap plate 38 and secondary energy storage device 10 may not be susceptible to leaking electrolyte or changing shape due to pressure and may instead be suitable for long-term testing and cycling, i.e., charging and discharging, under harsh or abusive conditions that may be expected during field operation of the secondary energy storage device 10. That is, although the thermistor 58 is disposed within the cavity 24, a mechanical and structural integrity of the cap plate 38 may be preserved and the secondary energy storage device 10 may therefore be subjected to long-term cycling and high-pressure testing under expected real-world operating conditions rather than merely short-term cycling and low-pressure testing under artificial operating conditions.

The thermistor 58 may change electrical resistance based on temperature. The thermistor 58 may be a negative temperature coefficient thermistor 58 in which the electrical resistance decreases as temperature increases. Alternatively, the thermistor 58 may be a positive temperature coefficient thermistor 58 in which the electrical resistance increases as temperature increases.

Further, since the thermistor 58 is disposed within the cavity 24, the thermistor 58 may accurately measure an internal temperature of the secondary energy storage device 10 and may provide for increased measurement and monitoring accuracy of internal conditions of the secondary energy storage device 10. That is, as compared to attaching the thermistor 58 on an external section of the secondary energy storage device 10, such as on an interconnect board (not shown) or other surface, the internal placement of the thermistor 58 described herein avoids inaccurate temperature monitoring and measurement due to noise factors such as convection from environmental air; conduction of components such as busbars; and geometric dimensioning and tolerancing risks associated with subpar contact between the thermistor 58 and the external section, which can in turn promote loss of state of health of the secondary energy storage device 10.

Further, placement of the thermistor 58 within the cavity 24 may minimize overly conservative calibration of the secondary energy storage device 10 and maximize performance of the secondary energy storage device 10. That is, disposing the thermistor 58 within the cavity 24 rather than on an exterior of the secondary energy storage device 10 without requiring a tear or cut and resealing of the cap plate 38 or rigid enclosure 22 allows for optimizing or rightsizing a performance of the secondary energy storage device 10 based on an accurate internal temperature measurement that is unaffected by exterior noise factors such as convection, conduction from other welds or components, electrical interference, and the like. For example, the internal thermistor 58 allows for heating the secondary energy storage device 10 to a precise specified temperature that is not influenced by comparatively cooler air in the environment 44 (FIG. 3) ambient to the device 10 and does not require overcompensation heating due to such cooler air. Conversely, the internal thermistor 58 may avoid overly conservative calibration of the device 10 based on, for example, a busbar heating the device 10 to a higher-than-desired temperature and a battery management system 100 (FIG. 3) throttling a power and performance of the device 10.

In one non-limiting example, the thermistor 58 may have an electrical resistance of from 1 kiloohm (kΩ) to 150 kΩ at 25 degrees Celsius (°C). For example, the thermistor 58 may have an electrical resistance of from 10 kΩ to 125 kΩ, or from 25 kΩ to 100 kΩ, at 25 °C. In one non-limiting example, the thermistor 58 may be a 50 kΩ thermistor 58 and have an electrical resistance of 50 kΩ at 25 °C. Further, the thermistor 58 may have a comparatively small dimension and low profile which may advantageously allow for the secondary energy storage device 10 to be compressed or stacked to form the pack 20 (FIG. 2), cycled extensively, and placed in a vacuum without concern of changing a shape or structural integrity of the secondary energy storage device 10 due to changes in internal pressure. The comparatively small size of the thermistor 58 may also be less likely to influence temperature measurement and testing results as compared to other comparatively larger thermistors.

Referring again to FIG. 3, the secondary energy storage device 10 further includes a first sensing conduit 60 electrically connected to the external portion 48. In addition, the secondary energy storage device 10 includes a second sensing conduit 62 electrically connected to the cap plate 38. The first sensing conduit 60 and the second sensing conduit 62 may each be an electrical wire configured to transmit electrical signals and sense and measure electrical activity of the external portion 48 and the cap plate 38.

The first sensing conduit 60 and the second sensing conduit 62 may be electrically connected to the external portion 48 and cap plate 38, respectively, by welding 64 (FIG. 5). That is, the secondary energy storage device 10 may include a third weld joint 66 (FIG. 3) electrically connecting the first sensing conduit 60 and the external portion 48 and a fourth weld joint 68 (FIG. 3) electrically connecting the second sensing conduit 62 and the cap plate 38. Further, although the second sensing conduit 62 is shown as electrically connected to the cap plate 38 near or adjacent to the external portion 48 of the negative electrode 32, it is to be appreciated that the second sensing conduit 62 may be electrically connected to another desired portion or at another desired location on the cap plate 38.

Referring now to FIG. 4, the secondary energy storage device 10 may also include a third conduit 70 electrically connecting the internal portion 30 and the thermistor 58. Further, the secondary energy storage device 10 may include a fourth conduit 72 extending through the void 52 and electrically connecting the thermistor 58 and the cap plate 38. The secondary energy storage device 10 may also include a first weld joint 74 electrically connecting the third conduit 70 and the internal portion 30 and a second weld joint 76 electrically connecting the fourth conduit 72 and the cap plate 38. However, as shown in FIGS. 3 and 4, the third conduit 70 and the fourth conduit 72 may not extend through the cap plate 38. That is, the cap plate 38 may not be cut or sliced or opened to pass the third conduit 70 and the fourth conduit 72 through the cap plate 38. Therefore, the structural and mechanical integrity of the cap plate 38 and secondary energy storage device 10 may be preserved.

### Secondary Energy Storage System

As described with continued reference to FIG. 3, the secondary energy storage system 12 includes the secondary energy storage device 10 as set forth above and the battery management system 100 electrically connected to the first sensing conduit 60 and the second sensing conduit 62 and configured for monitoring and measuring at least one of a voltage, temperature, and current flow of the secondary energy storage device 10. Further, although not shown, the secondary energy storage system 12 may include a plurality of the secondary energy storage devices 10 each electrically connected to one another and to the battery management system 100.

The battery management system 100 may be a specialized electronic system that monitors and controls operation of one or more of the secondary energy storage devices 10. For example, the battery management system 100 may track voltage, current, temperature, and state of charge for one or more of the secondary energy storage devices 10. Further, the battery management system 100 may monitor operating conditions for overcharging, over-discharging, short circuits, and unexpected temperature extremes. In addition, the battery management system 100 may balance or equalize an electrical charge across multiple ones of the plurality of secondary energy storage devices 10 to maximize capacity and operating life of the system 12. The battery management system 100 may also calculate state of charge and state of health for the system 12 to determine remaining capacity and condition of one or more of the secondary energy storage devices 10. The battery management system 100 may control one or more cooling systems (not shown) of the secondary energy storage system 12 to maintain optimal operating temperatures, may communicate status of the system 12 to other components, and may record performance metrics for diagnostics and maintenance of the secondary energy storage device(s) 10 and system 12.

In one example shown in FIG. 3, the battery management system 100 may include a voltage divider circuit 78 including a pull-up resistor 80. In particular, the voltage divider circuit 78 may employ a series of resistors to divide an input voltage and produce a smaller output voltage. One or more of the resistors may be the pull-up resistor 80 and may ensure that an electrical signal is at a specified high logic level or known state when not actively driven by another component of the battery management system 100. For example, the pull-up resistor 80 may define a clear state of a switch (not shown) of the battery management system 100 when the switch is open.

Therefore, in operation, the thermistor 58 may react to a change in temperature of the secondary energy storage device 10 and may relay an electrical signal via the third conduit 70 and the fourth conduit 72 to the first sensing conduit 60 and the second sensing conduit 62 and to the battery management system 100 so that an accurate internal temperature of the device 10 may be measured and monitored, even during long-term cycling of the device 10 or operation of the device 10 under harsh conditions, without electrolyte leakage or other compromise to the cap plate 38.

### Method of Forming the Secondary Energy Storage Device

Referring now to FIG. 5, the method 14 of forming the secondary energy storage device 10 includes inserting 82 the thermistor 58 into the cavity 24 defined by the rigid enclosure 22. As set forth above, inserting 82 may maintain the mechanical and structural integrity of the cap plate 38 and may not include tearing, cutting, or opening the cap plate 38 to thereby compromise the mechanical and structural integrity of the cap plate 38. That is, the thermistor 58 may not be inserted through the cap plate 38. Rather, inserting 82 may include placing the thermistor 58 within the cavity 24 before the cap plate 38 is attached to the front face 34 (FIG. 1).

After inserting 82, the method 14 includes electrically connecting 84 the thermistor 58 to the internal portion 30 and the cap plate 38 to thereby form a workpiece 86 (FIG. 3). That is, electrically connecting 84 the thermistor 58 may include forming the first weld joint 74 (FIG. 4) on the third conduit 70 to electrically connect the thermistor 58 and the internal portion 30 and forming the second weld joint 76 (FIG. 4) on the fourth conduit 72 to electrically connect the thermistor 58 and the cap plate 38. Stated differently, electrically connecting 84 the thermistor 58 may include forming the first weld joint 74 to electrically connect the third conduit 70 and the internal portion 30 and forming the second weld joint 76 to electrically connect the fourth conduit 72 and the cap plate 38.

As set forth above, the method 14 may also include, concurrent to electrically connecting 84, preserving 88 an integrity of the cap plate 38 such that the third conduit 70 and the fourth conduit 72 do not extend through the cap plate. That is, the method 14 may be free from cutting, tearing, opening, slicing, resealing, or otherwise compromising the cap plate 38.

Referring again to FIG. 5, the method 14 also includes, after electrically connecting 84 the thermistor 58, welding 64 the first sensing conduit 60 to the external portion 48 and the second sensing conduit 62 to the cap plate 38. That is, welding 64 may include, for each of the plurality of workpieces 86, forming the third weld joint 66 (FIG. 3) to electrically connect the first sensing conduit 60 and the external portion 48 and forming the fourth weld joint 68 (FIG. 3) to electrically connect the second sensing conduit 62 and the cap plate 38. As such, advantageously, the method 14 may merely include four weld joints 66, 68, 74, 76, i.e., two internal weld joints 74, 76 (FIG. 4) and two external weld joints 66, 68 (FIG. 3), which may allow for excellent manufacturing cycle times and cost-efficient manufacturing operations, and may minimize manufacturing challenges associated with cut cap plate sealing and sealant curing operations.

As described with continued reference to FIG. 5, the method 14 may also include, after welding 64 the first sensing conduit 60 and the second sensing conduit 62, disposing 90 the first sensing conduit 60 and the second sensing conduit 62 in electrical communication with the battery management system 100 (FIG. 3) configured for monitoring and measuring at least one of the voltage, temperature, and current flow of the secondary energy storage device 10. That is, the method 14 may include connecting the first sensing conduit 60 and the second sensing conduit 62 to the battery management system 100.

Referring again to FIG. 5, after electrically connecting 84 the thermistor 58 and prior to welding 64 the first sensing conduit 60 and the second sensing conduit 62, the method 14 may include electrically connecting 184 a plurality of the workpieces 86 (FIG. 3) to form the module 18 (FIG. 2) and pack 20 (FIG. 2). As such, forming the internal first weld joint 74 and the internal second weld joint 76 on individual ones of the secondary energy storage devices 10 may occur before electrically connecting 184 together the plurality of secondary energy storage devices 10. That is, forming the internal first and second weld joints 74, 76 to connect the thermistor 58 to the internal portion 30 and the cap plate 38 may occur while manufacturing or assembling each of the individual secondary energy storage devices 10, i.e., before the plurality of devices 10 are connected together during a second, separate manufacturing or assembly operation to form the module 18 or pack 20. Therefore, advantageously, welding 64 the external third weld joint 66 and the external fourth weld joint 68 may occur during a second, separate assembly operation, e.g., during manufacturing or assembly of the pack 18 or module 20.

As such, the method 14 may be useful for high volume manufacturing operations. In other words, the method 14 allows for individual components of the secondary energy storage device 10, e.g., the cap plate 38, the front face 34, the thermistor 58, and the like, to be manufactured first prior to pack 20 or module 18 assembly. That is, the method 14 allows for the individual workpieces 86 having the thermistor 58 already electrically connected to the internal portion 30 and the cap plate 38 within the cavity 24 to arrive at subsequent pack assembly operations fully assembled and process compliant for high volume manufacturing.

The method 14 may also include, after electrically connecting 84 the thermistor 58 to the internal portion 30 and cap plate 38, assembling the rigid enclosure 22 to thereby seal the cavity 24 from the environment 44 ambient to the cap plate 38. That is, prior to assembling, one or more portions of the rigid enclosure 22 may be brought into proximity with another portion or portions of the rigid enclosure 22. Assembling may then include welding together the rigid enclosure 22 to fully seal the cavity 24. For example, the method 14 may include attaching the cap plate 38 to the front face 34 by welding.

Therefore, in summary, the secondary energy storage device 10, system 12, and method 14 may be useful for applications requiring long-term testing and operation of secondary energy storage devices 10 under harsh conditions while accurately measuring and monitoring the internal temperature of the secondary energy storage device 10 and without compromising a structural integrity of the secondary energy storage device 10, even under conditions in which the secondary energy storage device 10 generates significant internal pressure. As such, the secondary energy storage device 10 may be suitable for applications requiring long-term cycling or operation of the secondary energy storage device 10 and system 12 in harsh or unexpected conditions, and the method 14 may be suitable for high-volume manufacturing requiring handling and multiple welding processes. In particular, the secondary energy storage device 10 may be useful for applications requiring prismatic lithium ion secondary batteries having excellent electrical conductivity, mechanical integrity, specific energy capacity, performance, manufacturing cost, and operating life.

The described embodiments of the present disclosure are intended to serve as non-limiting examples, and other embodiments may take various and alternative forms. In addition, the appended drawings are not necessarily to scale, and may present a somewhat simplified representation of various features of the present disclosure, including, for example, specific dimensions, orientations, locations, and shapes. Details associated with such features will be determined in part by the intended application and use environment of the described embodiments.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function. In addition, the use of ordinals such as first, second and third does not necessarily imply a ranked sense of order, but rather may merely distinguish between multiple instances of an act or structure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A secondary energy storage device comprising:
a rigid enclosure having a rectangular prism shape and defining a cavity therein;
wherein the rigid enclosure has:
a front face extending along a central longitudinal axis; and
a cap plate that contacts and is disposed perpendicular to the front face and extends along an axis that is parallel to the central longitudinal axis;
a negative electrode terminal electrically isolated from the cap plate and having an external portion disposed on the cap plate outside of the cavity and an internal portion extending into the cavity;
a thermistor disposed within the cavity and electrically connected to the internal portion and the cap plate;
a first sensing conduit electrically connected to the external portion; and
a second sensing conduit electrically connected to the cap plate.

2. The secondary energy storage device of claim 1, further including an insulation cover disposed between and in contact with the cap plate and the internal portion and defining a void therethrough.

3. The secondary energy storage device of claim 2, further including:
a third conduit electrically connecting the internal portion and the thermistor; and
a fourth conduit extending through the void and electrically connecting the thermistor and the cap plate.

4. The secondary energy storage device of claim 3, wherein the third conduit and the fourth conduit do not extend through the cap plate.

5. The secondary energy storage device of claim 3, further including:
a first weld joint electrically connecting the third conduit and the internal portion;
a second weld joint electrically connecting the fourth conduit and the cap plate;
a third weld joint electrically connecting the first sensing conduit and the external portion; and
a fourth weld joint electrically connecting the second sensing conduit and the cap plate.

6. The secondary energy storage device of claim 1, further including an insulator gasket disposed between and in contact with the external portion and the cap plate.

7. The secondary energy storage device of claim 1, wherein the thermistor has an electrical resistance of from 1 kiloohm (kΩ) to 150 kΩ at 25 degrees Celsius (°C).

8. The secondary energy storage device of claim 1, further including a positive electrode terminal and wherein the secondary energy storage device is a can-positive secondary energy storage device in which the cap plate is electrically connected to the positive electrode terminal and electrically isolated from the negative electrode terminal.

9. The secondary energy storage device of claim 1, further including a positive electrode terminal and wherein the secondary energy storage device is a can-neutral secondary energy storage device in which the cap plate is electrically isolated from the positive electrode terminal and the negative electrode terminal.

10. A vehicle including the secondary energy storage device of claim 1.

11. A secondary energy storage system comprising:
a secondary energy storage device including:
a rigid enclosure having a rectangular prism shape and defining a cavity therein;
wherein the rigid enclosure has:
a front face extending along a central longitudinal axis; and
a cap plate that contacts and is disposed perpendicular to the front face and extends along an axis that is parallel to the central longitudinal axis;
a negative electrode terminal electrically isolated from the cap plate and having an external portion disposed on the cap plate outside of the cavity and an internal portion extending into the cavity;
a thermistor disposed within the cavity and electrically connected to the internal portion and the cap plate;
a first sensing conduit electrically connected to the external portion; and
a second sensing conduit electrically connected to the cap plate; and
a battery management system electrically connected to the first sensing conduit and the second sensing conduit and configured for monitoring and measuring at least one of a voltage, temperature, and current flow of the secondary energy storage device.

12. The secondary energy storage system of claim 11, wherein the battery management system includes a voltage divider circuit including a pull-up resistor.

13. The secondary energy storage system of claim 11, further including:
an insulation cover disposed between and in contact with the cap plate and the internal portion and defining a void therethrough;
a third conduit electrically connecting the internal portion and the thermistor;
a fourth conduit extending through the void and electrically connecting the thermistor and the cap plate; and
wherein the third conduit and the fourth conduit do not extend through the cap plate.

14. The secondary energy storage system of claim 11, further including a plurality of secondary energy storage devices each electrically connected to one another and to the battery management system.

15. A method of forming a secondary energy storage device, the method comprising:
inserting a thermistor into a cavity defined by a rigid enclosure of the secondary energy storage device;
wherein the rigid enclosure has:
a prism shape;
a front face extending along a central longitudinal axis; and
a cap plate that contacts and is disposed perpendicular to the front face and extends along an axis that is parallel to the central longitudinal axis;
wherein the secondary energy storage device includes a negative electrode terminal electrically isolated from the cap plate and having an external portion disposed on the cap plate outside of the cavity and an internal portion extending into the cavity;
after inserting, electrically connecting the thermistor to the internal portion and the cap plate to thereby form a workpiece; and
after electrically connecting the thermistor, welding a first sensing conduit to the external portion and a second sensing conduit to the cap plate.

16. The method of claim 15, wherein the secondary energy storage device further includes:
an insulation cover disposed between and in contact with the cap plate and the internal portion and defining a void therethrough;
a third conduit electrically connecting the internal portion and the thermistor; and
a fourth conduit extending through the void and electrically connecting the thermistor and the cap plate; and
wherein electrically connecting the thermistor includes forming a first weld joint to electrically connect the third conduit and the internal portion and forming a second weld joint to electrically connect the fourth conduit and the cap plate.

17. The method of claim 16, further including, after electrically connecting the thermistor and prior to welding the first sensing conduit and the second sensing conduit, electrically connecting together a plurality of the workpieces.

18. The method of claim 17, wherein welding includes, for each of the plurality of workpieces, forming a third weld joint to electrically connect the first sensing conduit and the external portion and forming a fourth weld joint to electrically connect the second sensing conduit and the cap plate.

19. The method of claim 17, further including, after welding the first sensing conduit and the second sensing conduit, disposing the first sensing conduit and the second sensing conduit in electrical communication with a battery management system configured for monitoring and measuring at least one of a voltage, temperature, and current flow of the secondary energy storage device.

20. The method of claim 15, wherein the secondary energy storage device further includes:
an insulation cover disposed between and in contact with the cap plate and the internal portion and defining a void therethrough;
a third conduit electrically connecting the internal portion and the thermistor; and
a fourth conduit extending through the void and electrically connecting the thermistor and the cap plate; and
wherein the method further includes, concurrent to electrically connecting, preserving an integrity of the cap plate such that the third conduit and the fourth conduit do not extend through the cap plate.
